(19) United States
(12) Patent Application Publication
(10) Pub. No.: US 2008/0174936 A1
(43) Pub. Date: Jul. 24, 2008

(54) Apparatus and Method to Store Electrical Energy

(75) Inventors: James Chyi Lai, Saint Paul, MN (US); Tom Allen Agan, Saint Paul, MN (US)

Correspondence Address: THOMAS, KAYDEN, HORSTEMEYER & RISLEY, L.L.P., 15th Floor, 600 Galleria Parkway, Atlanta, GA, 30339-5994, US

(73) Assignee: WESTERN LIGHTS SEMICONDUCTOR CORP., Saint Paul, MN (US)

(21) Appl. No.: 11/624,738

(22) Filed: Jan. 19, 2007

(51) Int. Cl. H01G 4/06; H01G 4/40

(52) U.S. Cl. 361/311; 320/166

(57) ABSTRACT

An apparatus to store electrical energy has a first magnetic section, a second magnetic section and a dielectric section configured between the first magnetic section and the second magnetic section. The dielectric section is arranged to store electrical energy, and dipoles of the first magnetic section and the second magnetic section are arranged to prevent electrical energy leakage.

### BACKGROUND

1. Field of Invention

The present invention relates to an apparatus and method to store electrical energy. More particularly, the present invention relates to a magnetic device to store electrical energy.

2. Description of Related Art

Energy storage parts are very important in our life. Components such as capacitors used in the circuits and batteries used in portable devices, the electrical energy storage parts influence the performance and the working time of the electrical device.

However, traditional energy storage parts have some problems. For example, capacitors have a problem of current leakage decreasing overall performance. Batteries have the memory problem of being partially charged/discharged and decreasing overall performance.

The Giant Magnetoresistance Effect (GMR) is a quantum mechanical effect observed in structures with alternating thin magnetic and thin nonmagnetic sections. The GMR effect shows a significant change in electrical resistance from the zero-field high resistance state to the high-field low resistance state according to an applied external field.

Therefore, the GMR effect can be used to be the insulator with good performance. Thus, the apparatus with the GMR effect can be implemented to store electrical energy. For the foregoing reasons, there is a need to have a apparatus with the GMR effect to store electrical energy.

### SUMMARY

It is therefore an objective of the present invention to provide an apparatus and method to store electrical energy.

According to one embodiment of the present invention, the apparatus has a first magnetic section, a second magnetic section and a dielectric section configured between the first magnetic section and the second magnetic section. The dielectric section is arranged to store electrical energy. The first magnetic section and the second magnetic section with dipoles are arranged to prevent electrical energy leakage.

According to another embodiment of the present invention, the apparatus to store electrical energy has several magnetic sections, and several dielectric sections respectively configured between two neighbor magnetic sections. The dielectric sections are arranged to store electrical energy. The magnetic sections with dipoles are arranged to prevent electrical energy leakage.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 shows an apparatus to store electrical energy according to an embodiment of the invention;

FIG. 2 shows the apparatus when the apparatus is charging according to an embodiment of the invention;

FIG. 3 shows the apparatus when the apparatus is discharging according to an embodiment of the invention; and

FIG. 4 shows the apparatus according to another embodiment of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

All figures are drawn for ease of explanation of the basic teachings of the present invention only; the extensions of the figures with respect to number, position, relationship, and dimensions of the parts to form the embodiment will be explained or will be within the skill of the art after the following description has been read and understood.

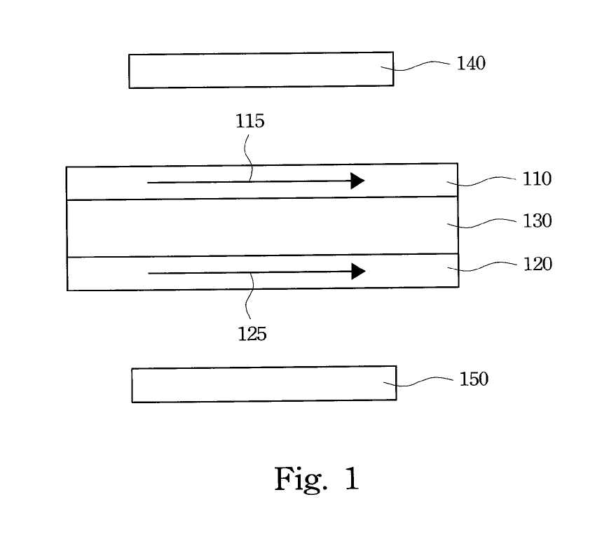

FIG. 1 shows an apparatus to store electrical energy according to an embodiment of the invention. The apparatus to store electrical energy has a first magnetic section 110, a second magnetic section 120, and a dielectric section 130 configured between the first magnetic section 110 and the second magnetic section 120. The dielectric section 130 is arranged to store electrical energy, and the first magnetic section 110 and the second magnetic section 120 with dipoles (such as 115 and 125) are arranged to prevent electrical energy leakage.

The dielectric section 130 is a thin film, and the dielectric section 130 is composed of dielectric material, such as BaTiO₃ or TiO₃. However, the dielectric material is not a perfect insulator. A small amount of current passes through the dielectric section 130.

Therefore, the first magnetic section 110 and the second magnetic section 120 are needed to generate the insulating-effect to prevent the current from passing through (i.e. electrical energy leakage). The first and second magnetic sections 110 and 120 are thin films, and these two magnetic sections with the dipoles are used to prevent electrical energy leakage.

The apparatus further has a first metal device 140 disposed around the first magnetic section 110, wherein the first metal device 140 is arranged to control the dipole 115 of the first magnetic section 110. The apparatus also has a second metal device 150 disposed around the second magnetic section 120, wherein the second metal device 150 is arranged to control the dipole 125 of the second magnetic section 120. The designer or user can use the first metal device 140 and the second metal device 150 to apply external fields to control the dipoles of the magnetic sections 110 and 120.

The positions of the metal device 140 and 150 showed in FIG. 1 are not arranged to restrict the metal device's positions. The designer can configure the metal device according to the actual requirements.

From the description above, the designer can use the metal devices 140 and 150 to control the dipoles 115 and 125 of the magnetic sections 110 and 120, and to cooperate dipoles 115 and 125 with the dielectric section 130 to store electrical energy and prevent electrical energy leakage. When the apparatus stores electrical energy, the dipoles 115 ( [symbol] ) and 125 ( [symbol] ) of the first magnetic section 110 and the second magnetic section 120 are the same. Therefore, the first magnetic section 110 and the second magnetic section 120 prevent electrical energy leakage, and electrical energy can be stored in the dielectric section 130.

Namely, when the dipoles 115 and 125 of the first magnetic section 110 and the second magnetic section 120 are the same, the spin directions of the electrons of the dielectric section 130 point toward one direction. The current leakage is reduced thereby. When the current leakage is reduced, the energy is stored for a longer period of time and there is less loss of electrical energy.

It is noted that the symbols [symbol] are just arranged to represent the dipoles of the magnetic sections, and are not arranged to restrict the dipole directions.

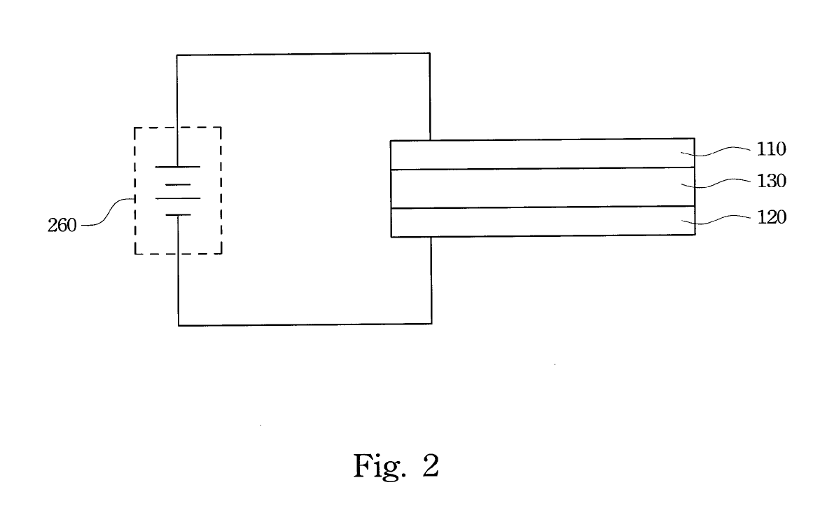

FIG. 2 shows the apparatus when the apparatus is charging according to an embodiment of the invention. When the apparatus is charged, the first magnetic section 110 and the second magnetic section 120 are coupled to a power source 260. The electrical energy can be inputted into the dielectric section 130 from the power source 260.

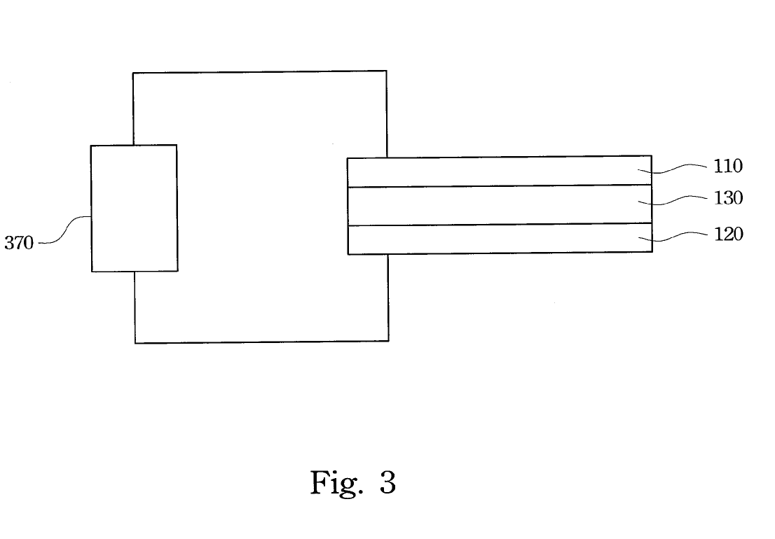

FIG. 3 shows the apparatus when the apparatus is discharging according to an embodiment of the invention. When the apparatus is discharged, the first magnetic section 110 and the second magnetic section 120 are coupled to a loading device 370. The electrical energy can be outputted from the dielectric section 130 to the loading device 370.

The power source or the loading device can influence the dipoles of the magnetic sections 110 and 120 easily, and the insulating-effect of the magnetic sections 110 and 120 is not good thereby. Therefore the current can be transmitted through the magnetic sections.

The apparatus can be viewed as a capacitor with large capacity. Moreover, the apparatus can be applied as a battery. The apparatus with battery function should not have the memory problem. Therefore, the apparatus can be fully or partially charged/discharged without loss of performance.

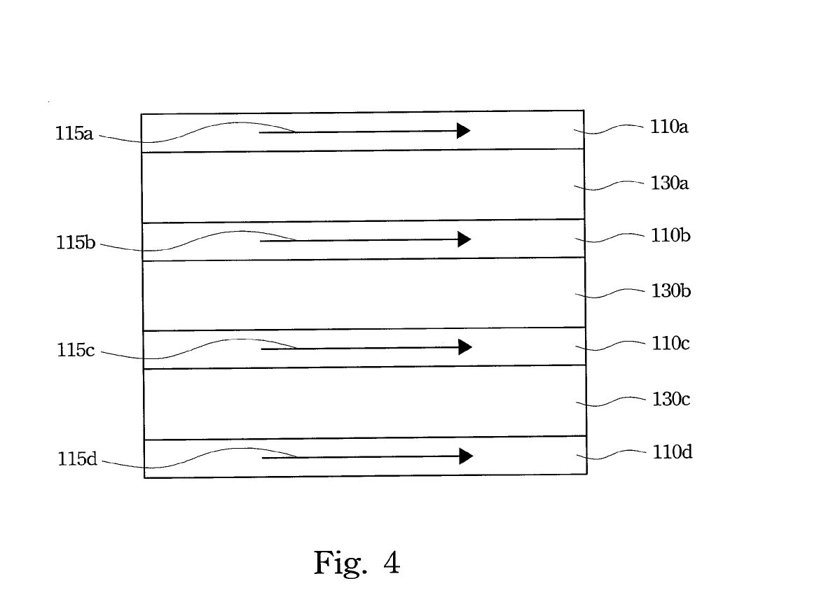

Otherwise, the apparatus can be used to create a large array of devices in parallel to obtain much larger energy storage. Moreover, several apparatus can be stacked up to obtain much larger energy storage as shown in FIG. 4.

The embodiment in FIG. 4 takes four magnetic sections 110a, 110b, 110c, 110d, and three dielectric sections 130a, 130b and 130c for example. The apparatus to store electrical energy has several magnetic sections 110a, 110b, 110c, 110d, and several dielectric sections 130a, 130b and 130c respectively configured between two neighboring magnetic sections. For example, the dielectric section 130a is configured between the magnetic sections 110a and 110b; the dielectric section 130b is configured between the magnetic sections 110b and 110c. The dielectric sections 130a, 130b and 130c are arranged to store electrical energy, and the magnetic sections 110a, 110b, 110c, 110d with dipoles 115a, 115b, 115c and 115d are arranged to prevent electrical energy leakage.

The apparatus further has several metal devices (not shown) respectively disposed around the magnetic sections to control dipoles of the magnetic sections.

When the apparatus stores electrical energy, the dipoles 115a, 115b, 115c and 115d of the magnetic sections 110a, 110b, 110c and 110d are the same.

When the apparatus is charged, the magnetic sections are partially coupled to a power source; when the apparatus is discharged, the magnetic sections are partially coupled to a loading device. Namely, when the apparatus is charged or discharged, the magnetic sections 110a and 110d couple to the power source or the loading device, or all the magnetic sections 110a, 110b, 110c and 110d couple to the power source or the loading device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus to store electrical energy, comprising:
a first magnetic section;
a second magnetic section; and
a dielectric section configured between the first magnetic section and the second magnetic section;
wherein the dielectric section is arranged to store electrical energy, and the first magnetic section and the second magnetic section with dipoles are arranged to prevent electrical energy leakage.

2. The apparatus of claim 1, wherein the dielectric section is a thin film.

3. The apparatus of claim 1, wherein the dielectric section is composed of dielectric material.

4. The apparatus of claim 1, wherein the first magnetic section is a thin film.

5. The apparatus of claim 1, wherein the second magnetic section is a thin film.

6. The apparatus of claim 1, further comprising a first metal device disposed around the first magnetic section to control dipole of the first magnetic section.

7. The apparatus of claim 1, further comprising a second metal device disposed around the second magnetic section to control dipole of the second magnetic section.

8. The apparatus of claim 1, wherein when the apparatus stores electrical energy, the dipoles of the first magnetic section and the second magnetic section are the same.

9. The apparatus of claim 1, wherein when the apparatus is charged, the first magnetic section and the second magnetic section are coupled to a power source.

10. The apparatus of claim 1, wherein when the apparatus is discharged, the first magnetic section and the second magnetic section are coupled to a loading device.

11. An apparatus to store electrical energy, comprising:
a plurality of magnetic sections; and
a plurality of dielectric sections respectively configured between two neighboring magnetic sections;
wherein the dielectric sections are arranged to store electrical energy, and the magnetic sections with dipoles are arranged to prevent electrical energy leakage.

12. The apparatus of claim 11, wherein the dielectric sections are a plurality of thin films.

13. The apparatus of claim 11, wherein the dielectric sections are composed of dielectric material.

14. The apparatus of claim 11, wherein the magnetic sections are a plurality of thin films.

15. The apparatus of claim 11, further comprising a plurality of metal devices respectively disposed around the magnetic sections to respectively control dipole of each of the magnetic sections.

16. The apparatus of claim 11, wherein when the apparatus stores electrical energy, the dipoles of the magnetic sections are the same.

17. The apparatus of claim 11, wherein when the apparatus is charged, partially the magnetic sections are coupled to a power source.

18. The apparatus of claim 11, wherein when the apparatus is discharged, partially the magnetic sections are coupled to a loading device.
